(19) United States
(12) Patent Application Publication
(10) Pub. No.: US 2006/0095726 A1
(43) Pub. Date: May 4, 2006

(54) Independent hardware based code locator

(75) Inventors: Abdelhafid Zaabab, Duluth, GA (US); Aashutosh Joshi, Lilburn, GA (US); Rajneesh Kumar Saint, Cupertino, CA (US)

Correspondence Address: IVIVITY, INC., 5555 OAKBROOK PKWY, SUITE 280, NORCROSS, GA, 30093-2286, US

(73) Assignee: iVivity, Inc.

(21) Appl. No.: 11/211,844

(22) Filed: Aug. 25, 2005

Related U.S. Application Data
(60) Provisional application No. 60/605,864, filed on Aug. 31, 2004.

(51) Int. Cl. G06F 9/40

(52) U.S. Cl. 712/205

(57) ABSTRACT

A hardware code relocator compiles code and executes starting at any address in memory. A hardware mechanism external to a CPU re-directs an instruction to the appropriate physical location in memory by adding a vector base offset to a fetch address and retrieving the instruction based upon a new fetch address.

### CROSS REFERENCE TO RELATED APPLICATIONS

This application claims priority to the U.S. provisional application No. 60/605,864 titled “Hardware Based Code Relocation” filed on 31 Aug. 2004, which is incorporated in its entirety by reference.

### TECHNICAL FIELD

The invention relates generally to the field of multi-processing, and more particularly, to compiling and executing code starting at any address in the memory.

### BACKGROUND OF THE INVENTION

A CPU, when released from reset will start fetching and executing code from a fixed known hard-coded reset vector address, which is usually zero (0x0). A given CPU code program will have imbedded data and routine references and the Operating System (OS) will compile and link the code with respect to this hard-coded address (0x0). Accordingly, the generated code bitmap has to be stored in memory starting at that hard-coded location (0x0) for the CPU to fetch and execute the code properly. For multi-processor designs where each CPU executes a different program code, the programmer is faced with the dilemma of how to compile and link the code for each CPU and where to store it in memory. Coupled is the challenge to produce concise code and use of the memory space efficiently.

Prior solutions to this problem were first to use either the same default hard coded start fetch address as shown in FIG. 1a or a different hard-coded CPU reset address for each CPU in the design as depicted in FIG. 1b. These solutions add more complications, engineering time, and effort for the hardware design. In addition, in order to remove all imbedded data and routine references within each CPU software program code, these solutions generate a prohibitively long, slow, and costly code that will consume sizable memory space and requires significant software engineering time and effort. There is hence a requirement for an efficient hardware based code locator solution that is CPU and OS independent.

### SUMMARY OF THE INVENTION

The present multiple processor system compiles and executes code starting at any address in memory. A hardware mechanism external to a CPU re-directs an instruction fetch to the appropriate physical location in memory. The system includes multiple processors with at least one hardware based code locator. The hardware based locator adds a vector base offset to an instruction fetch address within the memory.

### BRIEF DESCRIPTION OF THE DRAWINGS

Benefits and further features of the present invention will be apparent from a detailed description of preferred embodiment thereof taken in conjunction with the following drawings, wherein like elements are referred to with like reference numbers, and wherein:

FIGS. 1a and 1b are hardware structures illustrating the prior art code fetching schemes.

FIG. 2 is a hardware structure illustrating a multi-CPU hardware based code locators with memory code allocations.

FIG. 3 is a hardware structure illustrating a code translation.

FIG. 4 is a hardware structure illustrating data load/store access with translation.

### DETAILED DESCRIPTION

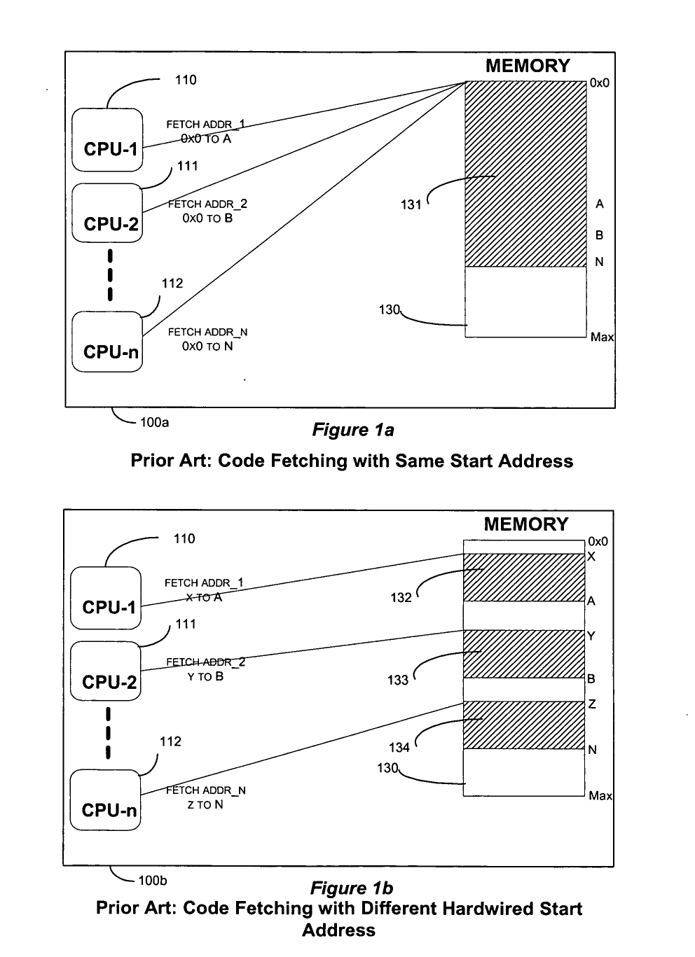

In FIG. 1a, all CPUs 110, 111, and 112 start fetching code at the same hard coded reset vector address, 0x0 in this example, from memory image code 131 stored in memory 130. If the CPUs need to execute different code, jump instructions are used to dispatch each CPU to a respective address within single code image 131. This method requires significant effort and special handling in generating the program code by combining all programs dedicated for each CPU.

In prior art FIG. 1b, however, each CPU 110, 111, until 112 has different hard coded reset vector. Hence, CPU 110 fetches code from his private code image space 132 starting from its reset vector address X, and CPU 111 fetches code from his private code image space 133 starting from its reset vector address Y, and CPU 112 fetches code from his private code image space 134 starting from its reset vector address Z.

In addition to software complications in generating the different image bitmaps for each CPU, because of the requirement to remove all imbedded data and routine references within each CPU software program code, a hardware complication is added because each CPU is now seen different than the others from hardware point of view because of the specific hard coded reset vector. This means each CPU must be synthesized and placed and routed separately which requires more hardware engineering time and effort.

A further drawback of the above prior art methods is the restriction on the placement of the code bitmap(s) in memory because of the fixed hard coded reset vectors.

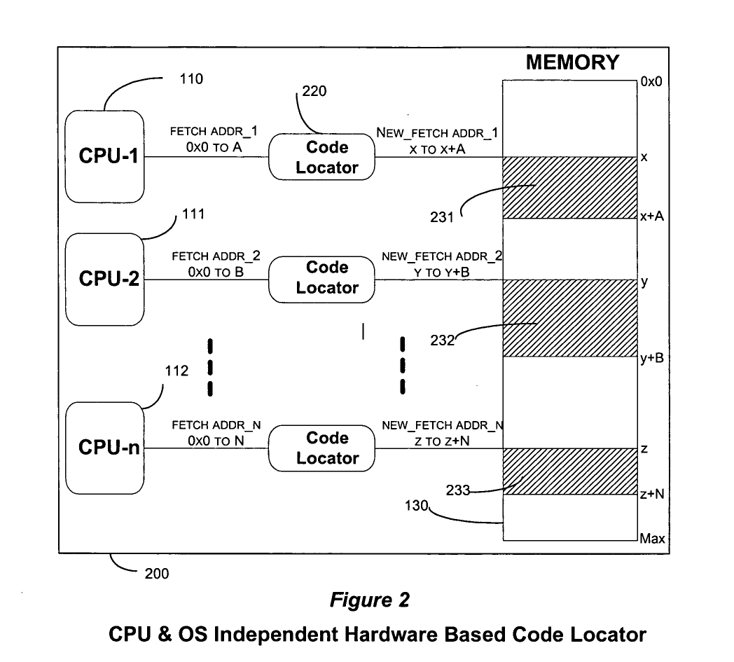

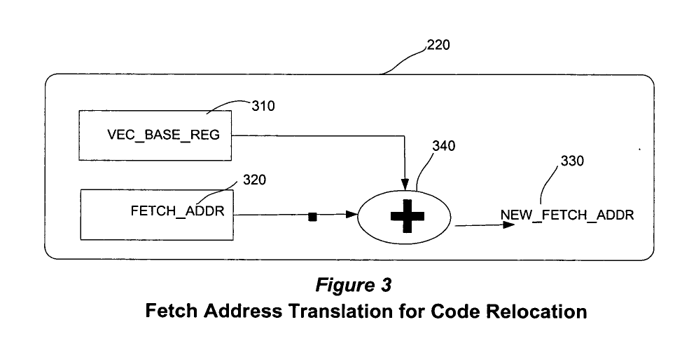

The present invention uses a hardware based code locator solution that is CPU and OS independent as depicted in FIG. 2 below. The re-direct mechanism, shown in FIGS. 2 and 3, is a programmable register that will translate the CPU generated address code fetches and load/stores to any desired address in memory. With this hardware re-direct mechanism, each CPU reset vector is left at its default conventional value of 0x0 and the OS will compile and link each CPU code with respect to its default start address of 0x0. Each CPU generated code bitmap would be placed anywhere in memory according to its on-the-fly software programmed re-direct register also called vec_base address register. An image size register is used in conjunction with the vec_base address register to allow translation only within the limits of the code bitmap size and bypass translation for direct memory accesses outside those limits.

Since the re-direct vec_base registers are programmable, CPU bitmaps can be placed differently anywhere in memory each time the code or code sizes change, or the memory requirements change to allow for an efficient usage of memory allocations.

A further advantage of this scheme is to allow all CPUs to execute the same bitmap if needed by just programming all re-direct vec_base registers to the same bitmap start address.

FIG. 2 below depicts a multiple processor system 200 where the multiple CPUs 110, 111, 112 have the same reset vector, 0x0 as in the example art, and each CPU uses a code locator circuit 220 to translate on the fly the code fetch address.

In this case, CPU 110 fetches program code with address fetch_addr_{—}1 starting at the default reset vector, 0x0, and its respective code locator 220 translates that address to new_fetch_addr_{—}1 that starts at vecbase address x in this example, to point to its respective bitmap image code 231. The same is true for the other CPUs. For example CPU 112 fetches program code with address fetch_addr_n starting at the default reset vector 0x0, and its respective code locator 220 translates that address to new_fetch_addr_n that starts at vec_base address z in this example, to point to its respective bitmap image code 233.

The code locator 220 is described in reference to FIG. 3. It consists of a vec_base programmable register 310 associated with each CPU. It can be programmed on the fly through the CPU external bus. For instance, CPU1 110 vec_base register 310 can be programmed to address x, CPU 2 111 vec_base register 310 can be programmed to address y, and CPU3 112 vec_base register 310 can be programmed to address z. For, every fetch cycle, the adder 340 in 220 translated the CPU fetch address 320 by adding it to the programmed vec_base value in 310 to generate the new fetch address new_fetch_addr 330.

Because the vec_base register 310 is programmable, the system becomes so flexible that the bitmap of each CPU can be placed anywhere in memory 130 each time the system is started or booted.

To further allow single bus CPUs access to data referenced and embedded within the code bitmap as well as provide access to other places of memory outside the code bitmap for data access, or for CPUs that have different busses for code fetch and data load/store, there is a need to allow the same translation to take place in the load/store data cycles but only within the range of the code image bitmap.

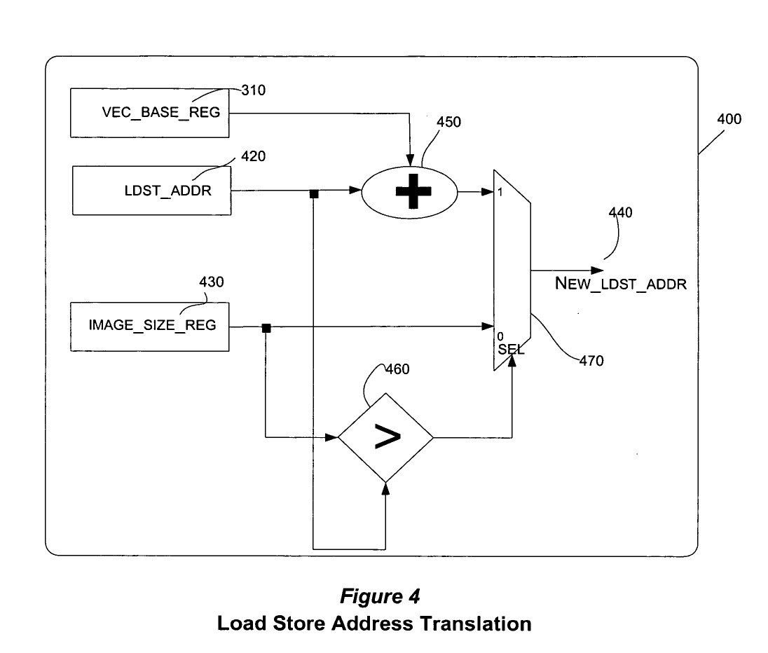

FIG. 4, block 400, depicts such a hardware block where an image size register 430 is used to hold the size of bitmap code in bytes. This register is also programmable as the vec_base register 310. Adder 450 performs the same translation on the load/store address cycle similar to the code fetch translation. Comparator 460 and multiplexer 470 make sure such translation occurs only within the code image addresses, as follows.:

If (0x0 or reset vector address)=<Ldst_addr<image_size→new_ldst_addr=ldst_addr+vec_base

else→new_ldst_addr=ldst_addr

With this hardware re-direct mechanism, each CPU reset vector is left at its default value of 0x0 and the OS will compile and link each CPU code with respect to its default start address of 0x0. Each CPU generated code bitmap would be placed anywhere in memory according to its on-the-fly software programmed re-direct vec_base register 310.

Since the vec_base registers are programmable, CPU bitmaps can be placed differently anywhere in memory each time the code or code sizes change, or the memory requirements change to allow for an efficient usage of memory allocations.

A further advantage of this scheme is to allow all CPUs to execute the same bitmap if needed for debugging for example by just programming all re-direct registers to the same bitmap start address.

Hardware resources and engineering stand to gain from this new process as all CPUs are exactly identical now and hence only one is to be synthesized, routed, and then placed in the system on the chip (SOC) as many times as required.

In view of the foregoing, it will be appreciated that the present system provides a method to compile code and execute starting at any address in the memory versus starting the code at address location zero or a hard coded address location. A mechanism external to CPU constantly re-directs the instruction fetches & the data load/store operation to the appropriate location in memory.

It should be understood that the foregoing relates only to the exemplary embodiments of the present invention, and that numerous changes may be made therein without departing from the spirit and scope of the invention as defined by the following claims. Accordingly, it is the claims set forth below, and not merely the foregoing illustrations, which are intended to define the exclusive rights of the invention.

1. A method for instruction fetching comprising the steps:
receiving a fetch address in a hardware block external from a CPU;
adding a vector base offset; and
retrieving the instruction based upon a new fetch address.

2. The method of claim 1 wherein the CPU has a reset vector address value equaling the first address location value in the memory.

3. The method claim 1 comprising the steps:
receiving second fetch address in second hardware block from a second CPU;
adding a second vector base offset; and
retrieving a second instruction based upon a new second fetch address.

4. The method for hardware based instruction fetch translation comprising the steps:
comparing a fetch address to a previously determined address value;
determining whether the fetch address is outside the determined address value;
adding a vector base offset when the fetch address is within the determined address value and not adding a vector base offset when the fetch address is outside the determined address value;
fetching the instruction based upon a new fetch address.

5. A method for instruction fetching comprising the steps:
receiving an instruction fetch address in a hardware block external from a CPU;
adding a vector base offset;
retrieving a instruction based upon a new instruction fetch address;
receiving a data fetch address;
comparing the data fetch address to a previously determined address value;
determining whether the data fetch address is outside the determined address value;
adding the vector base offset when the data fetch address is within the determined address value and not adding the vector base offset when the data fetch address is outside the determined address value;
fetching data based upon a new data fetch address.

6. The system of claim 5 wherein the CPU has a reset vector address value equaling a first address location value in the memory.

7. A system for multiple processor fetching comprising:
a plurality of processors;
at least one hardware based code locator, wherein the at least one hardware based locator is coupled to at least one processor;
the at least one hardware based locator adds a vector base offset to an instruction fetch address; and
memory coupled the at least one hardware based locator for storing information.

8. The system of claim 5 wherein each CPU has an identical reset vector address value.

9. The system of claim 6 wherein the reset vector address value equals a first address location value in the memory.
